(19) United States
(12) Patent Application Publication
(10) Pub. No.: US 2022/0253327 A1
(43) Pub. Date: Aug. 11, 2022

(54) CONTROL DEVICE AND CONTROL METHOD FOR MULTIPLE VIRTUAL MACHINES

(71) Applicant: FUJITSU LIMITED, Kawasaki-shi (JP)

(72) Inventor: Hiroyoshi KODAMA, Isehara (JP)

(73) Assignee: FUJITSU LIMITED, Kawasaki-shi (JP)

(21) Appl. No.: 17/520,161

(22) Filed: Nov. 5, 2021

(30) Foreign Application Priority Data
Feb. 5, 2021 (JP) 2021-017022

(51) Int. Cl. G06F 9/455; G06F 9/50

(52) U.S. Cl. CPC G06F 9/45558; G06F 2009/45583; G06F 9/5016

(57) ABSTRACT

A control device controls multiple virtual machines. Among one or more virtual machines that operate in a first information processing device, a virtual machine preferable to operate in a second information processing device included in the information processing system is identified as a virtual machine to be move, and the identified virtual machine is moved from the first information processing device to the second information processing device. The first information processing device includes a first memory, but does not include a first storage device having a storage capacity larger than a storage capacity of the first memory and to be used in place of the first memory, and the second information processing device includes a second memory, and includes a second storage device having a storage capacity larger than a storage capacity of the second memory and to be used in place of the second memory.

### CROSS-REFERENCE TO RELATED APPLICATION

This application is based upon and claims the benefit of priority of the prior Japanese Patent Application No. 2021-17022, filed on Feb. 5, 2021, the entire contents of which are incorporated herein by reference.

### FIELD

The embodiment discussed herein is related to a control technique for multiple virtual machines.

### BACKGROUND

In recent years, the performance of physical servers has improved due to an increase in the number of CPU cores included in a central processing unit (CPU) and the like. Accordingly, it is possible to construct many virtual servers in one physical server, and thus a service for providing those virtual servers to users has become a main cloud service.

Cloud service providers that provide virtual servers focus on improving the operational efficiency of physical servers. For example, a virtual server with a low use frequency hinders the improvement of the operational efficiency. Since the resources of the physical server such as a CPU core and a memory are divided and allocated to the virtual server, the resources of the physical server are not effectively utilized when the number of virtual servers with a low use frequency increases. A virtual server is sometimes called a virtual machine (VM).

FIG. 1 illustrates an exemplary VM. A server 101 of FIG. 1 is a physical server, and includes a CPU 111 and a memory 112. The CPU 111 includes eight CPU cores, and the memory 112 has a storage area of 384 gigabytes (GB).

In the server 101, VMs 102-1 to 102-5 are operating. One CPU core and a storage area of 64 GB are allocated to each of the VMs 102-1 to 102-3 and the VM 102-5. On the other hand, four CPU cores and a storage area of 128 GB are allocated to the VM 102-4. In a case where the VM 102-4, to which many resources are allocated, is not used much in the server 101, the operational efficiency of the server 101 decreases.

In relation to virtual machines, there has been known a technique of identifying a virtual machine in an idle state. There has also been known an information processing device that improves the performance of data reading and writing using a virtual machine. There has also been known a server system that increases the possibility that an appropriate migration method is selected as a method of migrating a virtual server.

Japanese Laid-open Patent Publication No. 2014-191368, Japanese Laid-open Patent Publication No. 2019-21185, and Japanese Laid-open Patent Publication No. 2011-248616 are disclosed as related art.

### SUMMARY

According to an aspect of the embodiments, a control device including a program memory and a processor coupled to the program memory and configured to identify, among one or more virtual machines that operate in a first information processing device included in an information processing system, a virtual machine preferable to operate in a second information processing device included in the information processing system as a virtual machine to be moved, and control to move the virtual machine to be moved from the first information processing device to the second information processing device, wherein the first information processing device includes a first memory, but does not include a first storage device having a storage capacity larger than a storage capacity of the first memory and to be used in place of the first memory, the second information processing device includes a second memory, and includes a second storage device having a storage capacity larger than a storage capacity of the second memory and to be used in place of the second memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a VM;

FIG. 2 is a functional configuration diagram of a control device;

FIG. 3 is a flowchart of a control process;

FIG. 4 is a configuration diagram of an information processing system;

FIG. 5 is a functional configuration diagram of a control server;

FIG. 6 is a hardware configuration diagram of a server;

FIG. 7 is a hardware configuration diagram of an SCM server;

FIG. 8 is a diagram illustrating a bandwidth of a DCPM;

FIG. 9 is a diagram illustrating a VM built in a server

FIG. 10 is a diagram illustrating changes in a memory usage of the VM

FIG. 11 is a diagram illustrating the memory usage in a simulation based on a benchmark

FIG. 12A is a flowchart (Part 1) of the control process performed by the control server

FIG. 12B is a flowchart (Part 2) of the control process performed by the control server; an

FIG. 13 is a hardware configuration diagram of an information processing device.

### DESCRIPTION OF EMBODIMENTS

These days, with the advent of a storage device called a storage class memory (SCM), the performance of a physical server has further improved, and the number of VMs to be constructed in one physical server has also further increased. An SCM includes a resistive random access memory (ReRAM), a magnetoresistive random access memory (MRAM), and the like. A data center persistent memory (DCPM) manufactured by Intel Corporation is also a type of SCMs.

For example, a dynamic random access memory (DRAM) is used as a memory of a physical server, and a solid state drive (SSD) or a hard disk drive (HDD) is used as a storage device, for example. The storage capacity of the SCM is larger than that of the DRAM, and is smaller than that of the SSD and HDD. The price per unit storage capacity of the SCM is cheaper than that of the DRAM, and is more expensive than that of the SSD and HDD.

The DCPM is used by being inserted into a memory slot of a physical server, and operates in one of operational modes including a volatile mode and a non-volatile mode. There is no dynamic switching between the volatile mode and the non-volatile mode. The volatile mode and the non-volatile mode may also be referred to as a memory mode and an app direct mode, respectively.

In the volatile mode, the DCPM is used as a large-capacity memory in place of the DRAM installed as a memory in the physical server, and the DRAM is used as a cache of the DCPM.

An operating system (OS) recognizes the storage capacity of the DCPM as a memory capacity, and an access to the DCPM is controlled by a memory controller. An existing OS and application programs may be used as they are without modification. Hereinafter, an application program may be simply referred to as an application.

In a case where a large-capacity DCPM is installed in a physical server, swapping to a storage device such as an HDD is less likely to occur. Furthermore, in a case where a DCPM is installed in a physical server of a virtualization platform system, it becomes possible to accommodate more VMs.

The access speed of the DCPM is faster than that of the SSD, and is slower than that of the DRAM. In the DCPM, a transfer speed differs between a read access and a write access, and the read access is faster than the write access.

In the non-volatile mode, the DCPM is used as a large-capacity non-volatile memory or a high-speed storage device. In this case, the OS and applications are modified and used.

As described above, the DRAM and the SCM are different in performance and cost. Therefore, in an information processing system in which a physical server without an SCM and a physical server with an SCM coexist, it is preferable to place an appropriate VM depending on characteristics of the storage device installed in each physical server. If VMs are not appropriately placed on multiple physical servers, the operational efficiency of the information processing system may decrease.

Note that such a problem is not limited to a physical server including an SCM, and it occurs in an information processing device (computer) with a storage capacity larger than that of a memory and including various storage devices to be used in place of the memory.

In one aspect, the present embodiment aims to improve the operational efficiency of an information processing system having a storage capacity larger than that of a memory and including an information processing device including a storage device to be used in place of the memory.

Hereinafter, an embodiment will be described in detail with reference to the drawings.

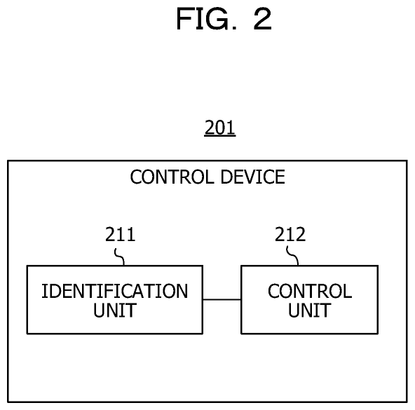

FIG. 2 illustrates an exemplary functional configuration of a control device according to the embodiment. A control device 201 of FIG. 2 includes an identification unit 211 and a control unit 212, and controls an information processing system including a first information processing device and a second information processing device.

The first information processing device includes a first memory. The first information processing device has a storage capacity larger than that of the first memory, and does not include a first storage device to be used in place of the first memory. The second information processing device includes a second memory. The second information processing device has a storage capacity larger than that of the second memory, and includes a second storage device to be used in place of the second memory.

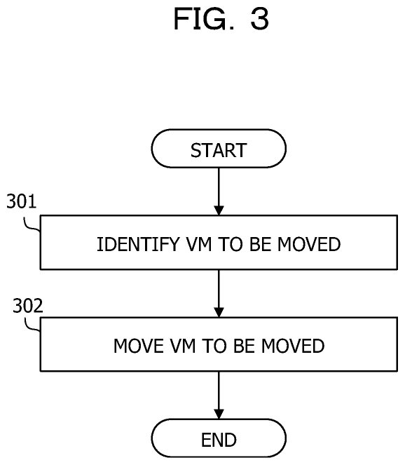

FIG. 3 is a flowchart illustrating an exemplary control process to be performed by the control device 201 of FIG. 2. First, the identification unit 211 identifies, as a VM to be moved, a VM preferable to operate in the second information processing device among one or a plurality of VMs operating in the first information processing device (step 301). Next, the control unit 212 performs control to move the VM to be moved from the first information processing device to the second information processing device (step 302).

According to the control device 201 of FIG. 2, it becomes possible to improve the operational efficiency of an information processing system having a storage capacity larger than that of a memory and including an information processing device including a storage device to be used in place of the memory.

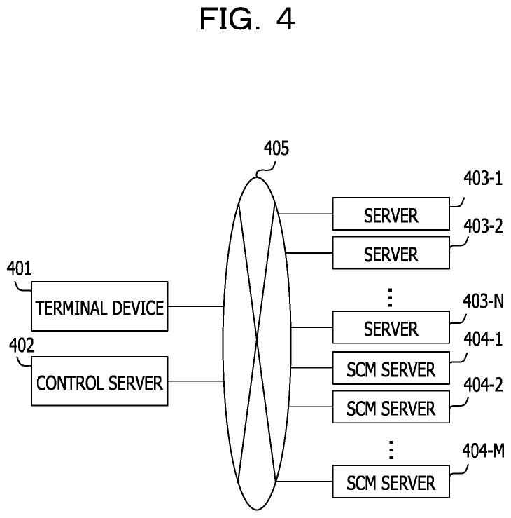

FIG. 4 illustrates an exemplary configuration of the information processing system including the control device 201 of FIG. 2. The information processing system of FIG. 4 includes a terminal device 401, a control server 402, servers 403-1 to 403-N (N is an integer of 1 or more), and SCM servers 404-1 to 404-M (M is an integer of 1 or more).

The control server 402, a server 403-i (i=1 to N), and an SCM server 404-j (j=1 to M) are physical servers. The server 403-i is a physical server that does not include an SCM, and the SCM server 404-j is a physical server that includes an SCM. The control server 402 corresponds to the control device 201 of FIG. 2, and the server 403-i and the SCM server 404-j correspond to the first information processing device and the second information processing device, respectively.

The terminal device 401, the control server 402, the server 403-i, and the SCM server 404-j are capable of communicating with each other via a communication network 405. The communication network 405 is, for example, a wide area network (WAN).

The information processing system of FIG. 4 is a virtualization platform system that provides a cloud service. The control server 402, the server 403-i, and the SCM server 404-j are information processing devices of a cloud service provider, and the terminal device 401 is an information processing device of a user who uses the cloud service.

In response to a construction request from the terminal device 401, the control server 402 constructs a plurality of VMs in the server 403-i or the SCM server 404-j, and provides them to the terminal device 401. For example, several tens to thousands of VMs are constructed.

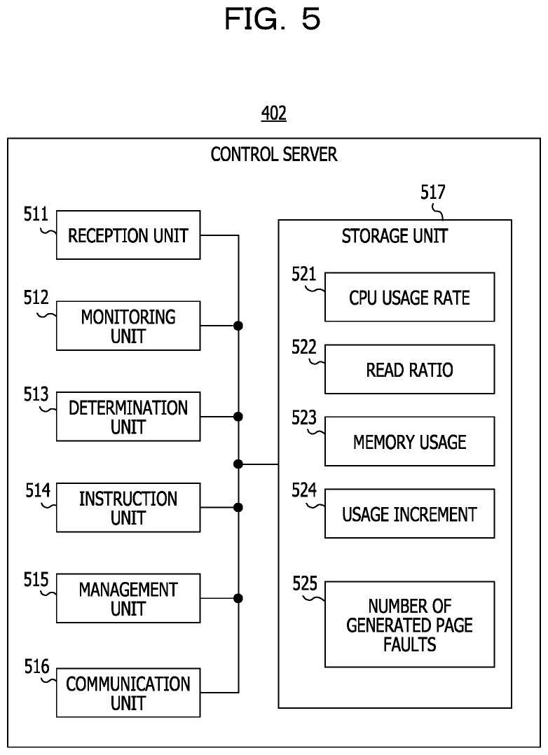

FIG. 5 illustrates an exemplary functional configuration of the control server 402 of FIG. 4. The control server 402 of FIG. 5 includes a reception unit 511, a monitoring unit 512, a determination unit 513, an instruction unit 514, a management unit 515, a communication unit 516, and a storage unit 517. The determination unit 513 and the instruction unit 514 correspond to the identification unit 211 and the control unit 212 of FIG. 2, respectively.

The communication unit 516 communicates with the terminal device 401, the server 403-i, and the SCM server 404-j via the communication network 405. The terminal device 401 transmits a construction request for constructing one or a plurality of VMs to the control server 402 on the basis of an instruction from the user, and the communication unit 516 receives the construction request.

The reception unit 511 accepts the received construction request, and transfers it to the instruction unit 514. The instruction unit 514 selects a server on which each VM indicated by the construction request is placed from among the servers 403-1 to 403-N and the SCM servers 404-1 to 404-M. Then, the instruction unit 514 instructs the management unit 515 to place each VM on the selected server.

The management unit 515 has a function of managing a virtualization platform, and requests generation of the VM instructed by the instruction unit 514 to the instructed server via the communication unit 516. The server that has received the request from the management unit 515 generates the requested VM. As a result, one or a plurality of VMs indicated by the construction request are constructed in the information processing system. The user logs in to each of the constructed VMs using the terminal device 401 to cause each VM to run the application.

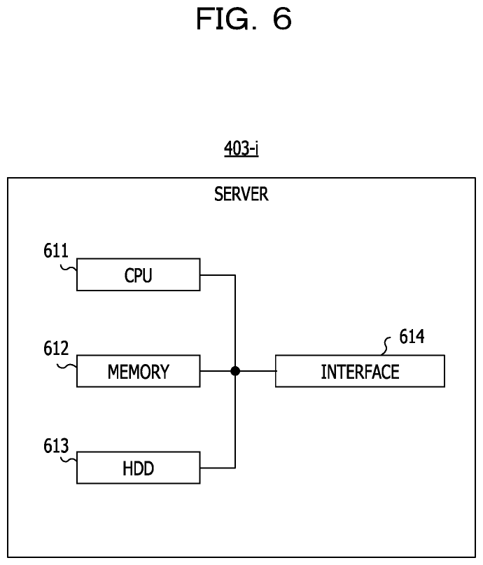

FIG. 6 illustrates an exemplary hardware configuration of the server 403-i of FIG. 4. The server 403-i of FIG. 6 includes a CPU 611, a memory 612, an HDD 613, and an interface 614. The CPU 611 is an exemplary arithmetic processing unit.

The CPU 611 generates a VM using the memory 612, and causes the generated VM to run the application. The HDD 613 stores data to be used by the application. The CPU 611 loads data from the HDD 613 to the memory 612, and causes the application to use the loaded data.

The interface 614 is a communication interface circuit, and is capable of communicating with the terminal device 401, the control server 402, and another server 403-i and SCM server 404-j via the communication network 405.

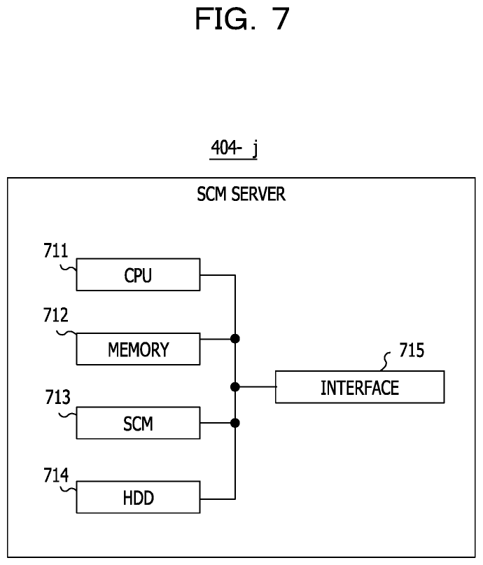

FIG. 7 illustrates an exemplary hardware configuration of the SCM server 404-j of FIG. 4. The SCM server 404-j of FIG. 7 includes a CPU 711, a memory 712, an SCM 713, an HDD 714, and an interface 715. A DCPM, ReRAM, MRAM, or the like is used as the SCM 713.

The SCM 713 has a storage capacity larger than that of the memory 612 and the memory 712, and is used in place of the memory 712. As a result, the storage capacity of the memory 612 is expanded. The OS recognizes the storage capacity of the SCM 713 as a memory capacity, and recognizes the usage of the SCM 713 as a memory usage. The memory 712 is used as a cache for the SCM 713.

The CPU 711 generates a VM using the SCM 713, and causes the generated VM to run the application. The HDD 714 stores data to be used by the application. The CPU 711 loads data from the HDD 714 to the SCM 713, and causes the application to use the loaded data.

The interface 715 is a communication interface circuit, and is capable of communicating with the terminal device 401, the control server 402, the server 403-i, and another SCM server 404-j via the communication network 405.

The monitoring unit 512 of FIG. 5 monitors whether or not there is a login to each VM and whether or not there is a process caused by the application running in each VM. The monitoring unit 512 further monitors a CPU usage rate, a read ratio, a memory usage, and occurrence of a page fault of each VM operating in each server 403-i.

The CPU usage rate of the VM indicates the CPU usage rate of the CPU 611. The CPU usage rate is an exemplary usage rate of the arithmetic processing unit.

The read ratio of the VM indicates a ratio of the number of read accesses to the memory 612 to the sum of the number of read accesses and the number of write accesses to the memory 612 within a unit period. For example, a period from the start to the end of a predetermined process of the application is used as a unit period.

The memory usage of the VM indicates the size of the storage area used in the memory 612. The memory usage may be a ratio of the used storage area to the storage capacity of the memory 612. The page fault of the VM indicates a page fault in the memory 612.

The monitoring unit 512 measures the CPU usage rate, the read ratio, and the memory usage of each VM operating in each server 403-i, and stores them in the storage unit 517 as a CPU usage rate 521, a read ratio 522, and a memory usage 523, respectively.

The monitoring unit 512 stores, in the storage unit 517, an increment of the memory usage of each VM within a predetermined period of time as a usage increment 524. The predetermined period may be the most recent time in the range of 1 to 10 minutes. The monitoring unit 512 stores, in the storage unit 517, the number of page faults generated in each VM as a page fault occurrence number 525.

The determination unit 513 determines whether or not each VM operating in the respective servers 403-i is a VM preferable to operate in the SCM server 404-j, and identifies the VM preferable to operate in the SCM server 404-j as a VM to be moved. The determination for the VM is made on the basis of whether or not there is a login to the VM, whether or not there is a process running in the VM, the CPU usage rate 521 of the VM, the read ratio 522, the memory usage 523, the usage increment 524, and the page fault occurrence number 525.

The instruction unit 514 instructs the management unit 515 to perform migration of the identified VM to be moved. The migration of the VM to be moved indicates a process of moving the VM to be moved from the server 403-i on which the VM is operating to one of the SCM servers 404-j.

The management unit 515 requests the server 403-i on which the VM to be moved is operating to migrate the VM to be moved instructed by the instruction unit 514 via the communication unit 516. The server 403-i that has received the request from the management unit 515 moves the VM to be moved to the instructed SCM server 404-j.

VMs preferable to operate in the SCM server 404-j include a VM with a low use frequency, and a VM better suited for the SCM server 404-j than the server 403-i. For example, a VM not logged in by the user, a VM in which a process is not running, and a VM with the CPU usage rate 521 lower than a threshold value are determined to be a VM with a low use frequency.

Since the SCM 713 has a storage capacity larger than that of the memory 612, the SCM server 404-j is capable of accommodating more VMs than the server 403-i. Therefore, by moving the VM with a low use frequency to the SCM server 404-j, it becomes possible to allocate the resources of the server 403-i used by the VM to another VM with a higher use frequency, thereby improving the operational efficiency of the information processing system.

Since the read access is faster than the write access in the SCM 713, a VM with a large read ratio 522 is suitable for the SCM server 404-j. In view of the above, a VM with the read ratio 522 larger than a predetermined threshold value is determined to be a VM suitable for the SCM server 404-j.

By moving a VM with a large read ratio 522 to the SCM server 404-j, it becomes possible to allocate the resources of the server 403-i used by the VM to another VM with a small read ratio 522. As a result, the operational efficiency of the information processing system is improved.

Since the SCM 713 has a storage capacity larger than that of the memory 612, a VM with a large memory usage 523 is suitable for the SCM server 404-j. In view of the above, a VM with the memory usage 523 larger than a predetermined threshold value is determined to be a VM suitable for the SCM server 404-j. For the similar reason, a VM in which the usage increment 524 is a positive value is also determined to be a VM suitable for the SCM server 404-j.

By moving a VM with a large memory usage 523 to the SCM server 404-j, it becomes possible to allocate the resources of the server 403-i used by the VM to another VM with a small memory usage 523. Furthermore, by moving a VM in which the usage increment 524 is a positive value to the SCM server 404-j, it becomes possible to allocate the resources of the server 403-i used by the VM to another VM in which the usage increment 524 is a value 0 or less. As a result, the operational efficiency of the information processing system is improved.

Since the SCM 713 has a storage capacity larger than that of the memory 612, swapping of data to the HDD 714 is unlikely to occur. Occurrence of swapping is observed as occurrence of a page fault. Therefore, a VM with a large page fault occurrence number 525 is suitable for the SCM server 404-j. In view of the above, a VM with the page fault occurrence number 525 larger than a threshold value is determined to be a VM suitable for the SCM server 404-j.

By moving a VM with a page fault occurrence number 525 to the SCM server 404-j, it becomes possible to allocate the resources of the server 403-i used by the VM to another VM with a small page fault occurrence number 525. As a result, the operational efficiency of the information processing system is improved.

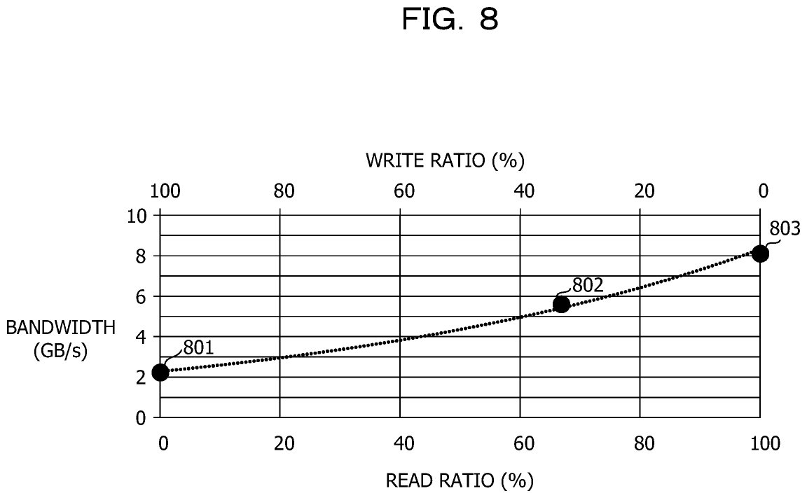

FIG. 8 illustrates an exemplary bandwidth of the DCPM used as the SCM 713 of FIG. 7. The horizontal axis represents a read ratio and a write ratio, and the vertical axis represents a bandwidth.

The read ratio indicates a ratio of the number of read accesses to the DCPM to the sum of the number of read accesses and the number of write accesses to the DCPM within a unit period. The write ratio indicates a ratio of the number of write accesses to the DCPM to the sum of the number of read accesses and the number of write accesses to the DCPM within the unit period. Therefore, the sum of the read ratio and the write ratio is 100%. The bandwidth indicates the average data transfer speed over multiple accesses.

The read ratio and the write ratio vary depending on the state of the process. For example, the read ratio of the process indicated by a point 801 is 0%, the write ratio is 100%, and the bandwidth is 2.2 GB/s. Since no read access is carried out in this case, the bandwidth indicates the average data transfer speed in the write access.

The read ratio of the process indicated by a point 802 is 67%, the write ratio is 33%, and the bandwidth is 5.6 GB/s. In this case, the bandwidth indicates the average data transfer speed in the access including the read access and the write access.

The read ratio of the process indicated by a point 803 is 100%, the write ratio is 0%, and the bandwidth is 8.1 GB/s. Since no write access is carried out in this case, the bandwidth indicates the average data transfer speed in the read access.

In this manner, unlike the DRAM, the read access to the DCPM is faster than the write access. However, the read access to the DCPM is slower than the read access and the write access to the DRAM.

Even if a process with a large read ratio is moved to the SCM server 404-j including the DCPM, it operates faster than a process with a smaller read ratio, and the operation delay is not very noticeable. Therefore, it can be said that a VM on which a process with a large read ratio is running is a VM suitable for the SCM server 404-j.

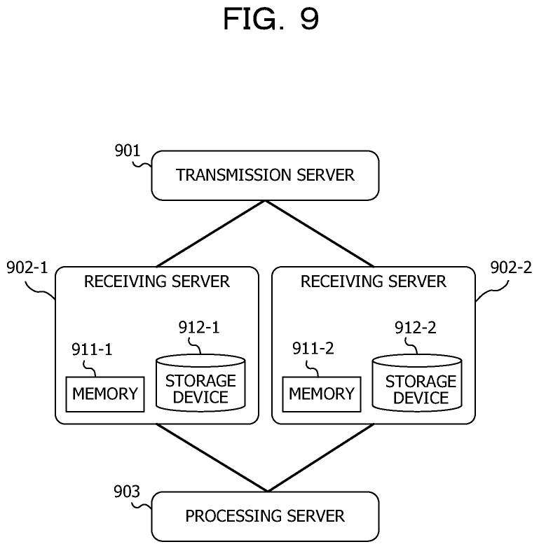

FIG. 9 illustrates an exemplary VM constructed inside the server 403-i of FIG. 6. A transmission server 901, a receiving server 902-1, a receiving server 902-2, and a processing server 903 are VMs. A receiving server 902-k (k=1, 2) includes a virtual memory 911-k and storage device 912-k.

The transmission server 901 transmits data of 256 GB to the receiving server 902-1 and to the receiving server 902-2, and the receiving server 902-1 and the receiving server 902-2 transmits the received data to the processing server 903.

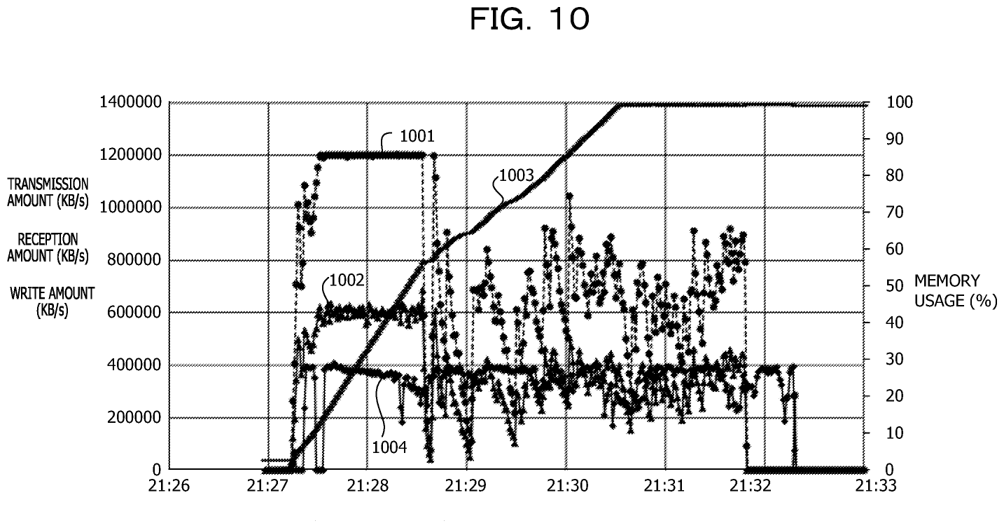

FIG. 10 illustrates an exemplary change in the memory usage of the VM illustrated in FIG. 9. The horizontal axis represents time, and the vertical axis represents a transmission amount, a reception amount, a write amount, or a memory usage. The transmission amount, the reception amount, the memory usage, and the write amount in FIG. 10 are data obtained using Apache Kafka (registered trademark), which is a distributed messaging system.

The memory usage indicates a ratio of the used storage area to the storage capacity of the memory 612.

A polygonal line 1001 represents a transmission amount (kB/s) of data transmitted by the transmission server 901. A polygonal line 1002 represents a reception amount (kB/s) of data received by each receiving server 902-k from the transmission server 901. A polygonal line 1003 represents a memory usage of the memory 911-k used by each receiving server 902-k. The memory usage of the memory 911-k corresponds to the memory usage of the memory 612. A polygonal line 1004 represents a write amount (kB/s) of data written by each receiving server 902-k to the storage device 912-k.

As indicated by the polygonal line 1001, the transmission server 901 initially transmits data to the receiving server 902-k at a transmission amount of 10 Gbps (1,250,000 kB/s). Since the receiving server 902-k writes the received data to the memory 911-k, the memory usage of the receiving server 902-k increases with a certain gradient as indicated by the polygonal line 1003. Then, at a time point when the memory usage reaches approximately 57%, the inclination of the polygonal line 1003 changes, and the reception amount indicated by the polygonal line 1002 decreases accordingly.

In this manner, in a case where the memory usage exceeds 50%, or in a case where the memory usage continues to increase, the processing efficiency of the VM decreases, and thus the VM is preferably moved to the SCM server 404-j having a larger storage capacity.

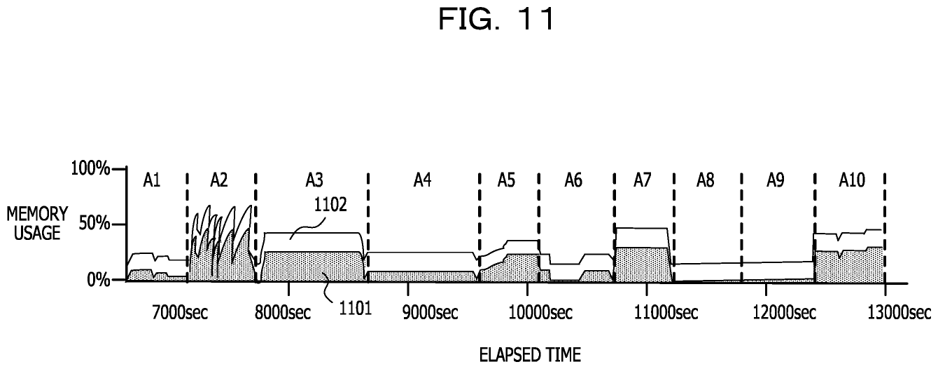

FIG. 11 illustrates an exemplary memory usage in a simulation based on a benchmark of SPEC CPU (registered trademark) 2017. The horizontal axis represents the elapsed time of the simulation using the server 403-i of FIG. 6, and the vertical axis represents the memory usage of the memory 612. A1 to A10 indicate the following applications specified in the benchmark.

A1 500.perlbench_rA2 502.gcc_rA3 505.mcf_rA4 520.omnetpp_rA5 523.xalancbmk_rA6 525.x264_rA7 531.deepsjeng_rA8 541.leela_rA9 548.exchange2_rA10 557.xz_r

An area 1101 indicates a memory usage used by each application for processing, and an area 1102 indicates a memory usage used as a page cache. The memory usage of the application A2 repeatedly increases and decreases while the application A2 is running. In this manner, some applications executed by the VM repeatedly consume and release the memory 612.

Although the memory usage of the application A2 has not reached 100%, a swap occurs between a page in the memory 612 and a page in the HDD 613 when it reaches 100% even for a short period of time. Since a page swap is carried out on the basis of notification of a page fault, occurrence of a swap is observed as occurrence of a page fault.

Therefore, in a case where one or a plurality of page faults occur, the processing efficiency of the VM decreases due to the swapping, and thus the VM is preferably moved to the SCM server 404-j having a larger storage capacity.

According to the information processing system of FIG. 4, among the VMs operating in the server 403-i, a VM with a low use frequency and a VM suitable for the SCM server 404-j are identified as VMs to be moved. By moving the identified VM to be moved from the server 403-i to the SCM server 404-j, it becomes possible to allocate the resources of the server 403-i used by the VM to another VM, thereby improving the operational efficiency of the information processing system.

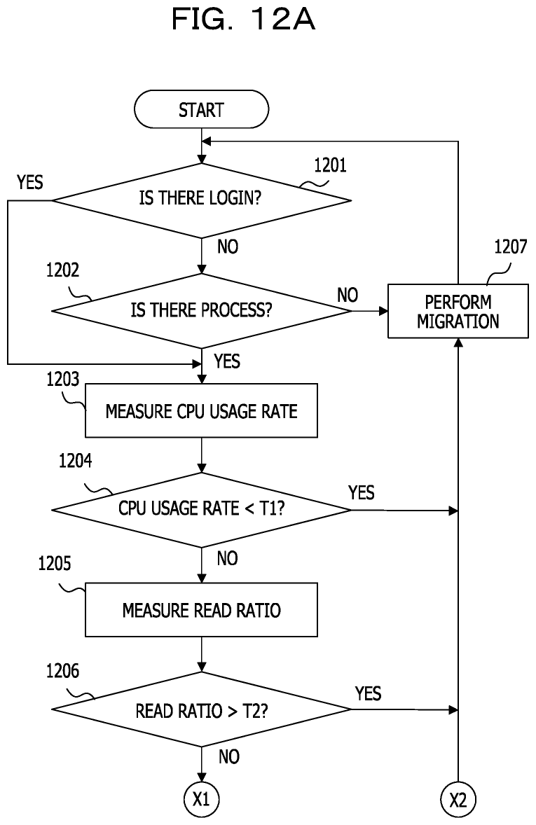

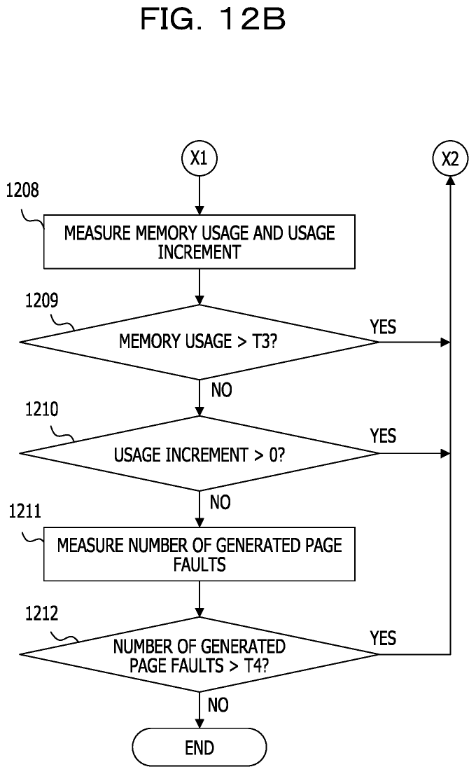

FIGS. 12A and 12B are flowcharts illustrating an exemplary control process to be performed by the control server 402 of FIG. 5. First, the monitoring unit 512 monitors whether or not there is a login of the user to each VM operating in each server 403-i, and whether or not there is a process caused by the application running in each VM.

The determination unit 513 checks whether or not the user has logged in to each VM operating in each server 403-i on the basis of a result of the monitoring by the monitoring unit 512 (step 1201). If the user has not logged in to any VM (NO in step 1201), the determination unit 513 checks whether or not there is a process running in the VM on the basis of the result of the monitoring by the monitoring unit 512 (step 1202).

If there is no process running in the VM (NO in step 1202), the determination unit 513 determines the VM as a VM to be moved. Then, the instruction unit 514 instructs the management unit 515 to perform migration for moving the determined VM to be moved to any SCM server 404-j (step 1207).

The management unit 515 requests the migration of the VM to be moved to the server 403-i on which the VM to be moved is operating, and the server 403-i moves the VM to be moved to the SCM server 404-j. Then, after a certain period of time has elapsed, the control server 402 repeats the processing of step 1201 and subsequent steps. The certain period of time may be a time in the range of several minutes to 20 minutes.

If there is a process running in the VM (YES in step 1202), the monitoring unit 512 measures the CPU usage rate 521 of the process (step 1203), and the determination unit 513 compares the CPU usage rate 521 of the process with a threshold value T1 (step 1204). The threshold value T1 is an example of a second threshold value. The threshold value T1 may be a value in a range of 3% to 10%.

If the CPU usage rate 521 of the process is lower than the threshold value T1 (YES in step 1204), the determination unit 513 determines the VM on which the process is running as a VM to be moved. Then, the control server 402 performs the processing of step 1207 and subsequent steps.

If the CPU usage rate 521 of the process is equal to or higher than the threshold value T1 (NO in step 1204), the monitoring unit 512 measures the read ratio 522 of the process (step 1205), and the determination unit 513 compares the read ratio 522 of the process with a threshold value T2 (step 1206). The threshold value T2 is an example of a third threshold value. The threshold value T2 may be a value in a range of 50% to 80%.

If the read ratio 522 of the process is higher than the threshold value T2 (YES in step 1206), the determination unit 513 determines the VM on which the process is running as a VM to be moved. Then, the control server 402 performs the processing of step 1207 and subsequent steps.

If the read ratio 522 of the process is equal to or lower than the threshold value T2 (NO in step 1206), the monitoring unit 512 measures the memory usage 523 and the usage increment 524 of the process (step 1208). Then, the determination unit 513 compares the memory usage 523 of the process with a threshold value T3 (step 1209). The threshold value T3 is an example of a first threshold value. The threshold value T3 may be a value in a range of 40% to 60%.

If the memory usage 523 of the process is higher than the threshold value T3 (YES in step 1209), the determination unit 513 determines the VM on which the process is running as a VM to be moved. Then, the control server 402 performs the processing of step 1207 and subsequent steps.

When the memory usage 523 of the process is equal to or lower than the threshold value T3 (NO in step 1209), the determination unit 513 checks whether or not the usage increment 524 of the process is positive (step 1210). When the usage increment 524 of the process is positive, it indicates that the memory usage 523 has increased within a predetermined period of time.

If the usage increment 524 of the process is positive (YES in step 1210), the determination unit 513 determines the VM on which the process is running as a VM to be moved. Then, the control server 402 performs the processing of step 1207 and subsequent steps.

If the usage increment 524 of the process is 0 or less (NO in step 1210), the monitoring unit 512 measures the page fault occurrence number 525 of the process (step 1211). The page fault occurrence number 525 of the process indicates the number of page faults occurred in the process. Then, the determination unit 513 compares the page fault occurrence number 525 of the process with a threshold value T4 (step 1212). The threshold value T4 may be a value in the range of 0 to 3 times.

If the page fault occurrence number 525 of the process is larger than the threshold value T4 (YES in step 1212), the determination unit 513 determines the VM on which the process is running as a VM to be moved. Then, the control server 402 performs the processing of step 1207 and subsequent steps. If the page fault occurrence number 525 of the process is equal to or smaller than the threshold value T4 (NO in step 1212), the control server 402 terminates the process.

If the user has logged in to all the VMs (YES in step 1201), the control server 402 performs the processing of step 1203 and subsequent steps for each process running in the respective VMs.

Note that the control server 402 does not need to identify the VM to be moved using all of the CPU usage rate 521, the read ratio 522, the memory usage 523, the usage increment 524, and the page fault occurrence number 525. The control server 402 may select one or a plurality of indexes from those indexes to identify the VM to be moved using only the selected indexes.

The configuration of the control device 201 of FIG. 2 is merely an example, and some constituent elements may be omitted or modified depending on the use or conditions of the control device 201.

The configuration of the information processing system of FIG. 4 is merely an example, and some constituent elements may be omitted or modified depending on the use or conditions of the information processing system. The configurations of the control server 402 of FIG. 5, the server 403-i of FIG. 6, and the SCM server 404-j of FIG. 7 are merely examples, and some constituent elements may be omitted or modified depending on the use or conditions of the information processing system.

For example, the management unit 515 of FIG. 5 may be provided in an external device of the control server 402. In this case, the instruction unit 514 instructs the management unit 515 to perform migration of the VM to be moved via the communication unit 516.

The flowcharts of FIGS. 3, 12A, and 12B are merely examples, and some processes may be omitted or modified depending on the configuration or conditions of the control device 201 or the information processing system. For example, in a case of not using the CPU usage rate 521, the processing of steps 1203 and 1204 may be omitted.

In a case of not using the read ratio 522, the processing of steps 1205 and 1206 may be omitted. In a case of not using the memory usage 523, the processing of step 1209 may be omitted. In a case of not using the usage increment 524, the processing of step 1210 may be omitted. In a case of not using the page fault occurrence number 525, the processing of steps 1211 and 1212 may be omitted.

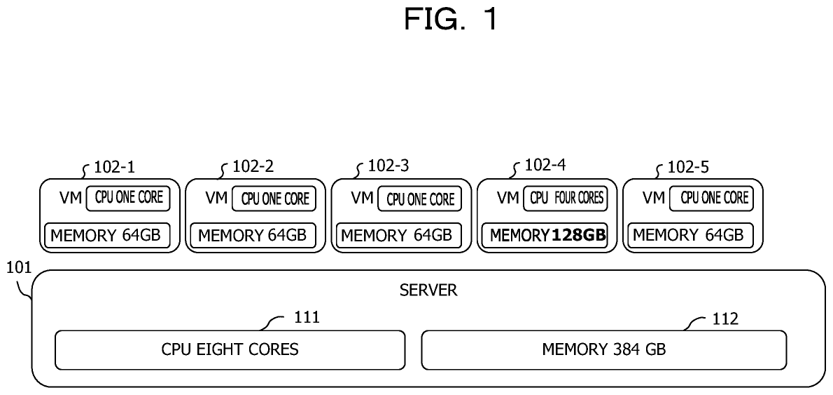

The VMs 102-1 to 102-5 illustrated in FIG. 1 and the VM illustrated in FIG. 9 are merely examples, and the VM to be constructed in the server changes depending on the construction request of the user.

The bandwidth illustrated in FIG. 8 is merely an example, and the bandwidth of the DCPM changes depending on the DCPM to be used. The memory usage of the VM illustrated in FIG. 10 is merely an example, and the memory usage of the VM changes depending on the VM to be constructed. The memory usage of the application illustrated in FIG. 11 is merely an example, and the memory usage of the application changes depending on the application.

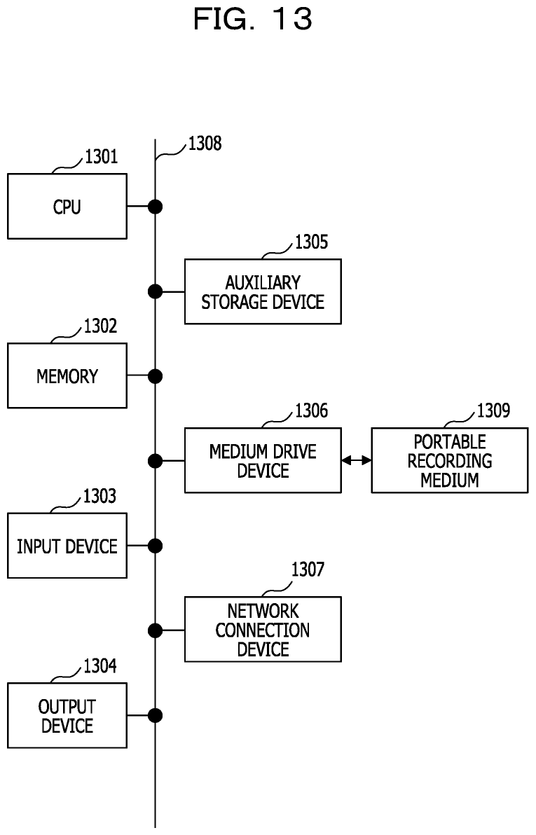

FIG. 13 illustrates an exemplary hardware configuration of the information processing device to be used as the control device 201 of FIG. 2 and the control server 402 of FIG. 5. The information processing device of FIG. 13 includes a CPU 1301, a memory 1302, an input device 1303, an output device 1304, an auxiliary storage device 1305, a medium drive device 1306, and a network connection device 1307. Those configuration elements are hardware, and are connected to each other by a bus 1308.

The memory 1302 is, for example, a semiconductor memory such as a read only memory (ROM) or a random access memory (RAM), and stores programs and data to be used for processing.

The memory 1302 may operate as the storage unit 517 of FIG. 5.

The CPU 1301 executes a program using the memory 1302 to operate as the identification unit 211 and the control unit 212 of FIG. 2, for example. The CPU 1301 executes a program using the memory 1302 to operate also as the reception unit 511, the monitoring unit 512, the determination unit 513, the instruction unit 514, and the management unit 515 of FIG. 5.

The input device 1303 is, for example, a keyboard, a pointing device, or the like, and is used for inputting an instruction or information from an operator. The output device 1304 is, for example, a display device, a printer, or the like, and is used for an inquiry or instruction to the operator and for outputting a processing result.

The auxiliary storage device 1305 is, for example, a magnetic disk device, an optical disk device, a magneto-optical disk device, a tape device, or the like. The auxiliary storage device 1305 may be an HDD. The information processing device is capable of saving programs and data in the auxiliary storage device 1305 and loading them into the memory 1302 to use them. The auxiliary storage device 1305 may operate as the storage unit 517 of FIG. 5.

The medium drive device 1306 drives a portable recording medium 1309, and accesses recorded content thereof. The portable recording medium 1309 is a memory device, a flexible disk, an optical disk, a magneto-optical disk, or the like. The portable recording medium 1309 may be a compact disk read only memory (CD-ROM), a digital versatile disk (DVD), a universal serial bus (USB) memory, or the like.

The operator is allowed to store the programs and data in the portable recording medium 1309 to use them by loading them into the memory 1302.

As described above, a computer-readable recording medium that stores the programs and data to be used for the processing includes a physical (non-transitory) recording medium such as the memory 1302, the auxiliary storage device 1305, or the portable recording medium 1309.

The network connection device 1307 is a communication interface circuit connected to the communication network 405 and performs data conversion associated with communication. The information processing device is capable of receiving programs and data from an external device via the network connection device 1307 to use them by loading them into the memory 1302. The network connection device 1307 may operate as the communication unit 516 of FIG. 5.

An information processing device similar to that of FIG. 13 is used as the terminal device 401 of FIG. 4. Note that the information processing device does not need to include all the configuration elements in FIG. 13, and some configuration elements may be omitted depending on the use or conditions of the information processing device. For example, in a case where an interface with the operator is not needed, the input device 1303 and the output device 1304 may be omitted. In a case of not using the portable recording medium 1309, the medium drive device 1306 may be omitted.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control device comprising:
a program memory, and
a processor coupled to the program memory and configured to:
identify, among one or more virtual machines that operate in a first information processing device included in an information processing system, a virtual machine preferable to operate in a second information processing device included in the information processing system as a virtual machine to be moved; and
control to move the virtual machine to be moved from the first information processing device to the second information processing device, wherein
the first information processing device includes a first memory, but does not include a first storage device having a storage capacity larger than a storage capacity of the first memory and to be used in place of the first memory, and
the second information processing device includes a second memory, and includes a second storage device having a storage capacity larger than a storage capacity of the second memory and to be used in place of the second memory.

2. The control device according to claim 1, wherein in the identify,
among the one or more virtual machines, a virtual machine that performs a process with a usage of the first memory larger than a first threshold value is identified as the virtual machine to be moved.

3. The control device according to claim 1, wherein in the identify,
among the one or more virtual machines, a virtual machine that performs a process in which a usage of the first memory has increased within a predetermined period of time is identified as the virtual machine to be moved.

4. The control device according to claim 1, wherein in the identify,
among the one or more virtual machines, a virtual machine that performs a process in which a page fault has occurred in the first memory is identified as the virtual machine to be moved.

5. The control device according to claim 1, wherein
the first information processing device further includes an arithmetic processing circuit, and
in the identify, among the one or more virtual machines, a virtual machine that performs a process with a usage rate of the arithmetic processing circuit smaller than a second threshold value is identified as the virtual machine to be moved.

6. The control device according to claim 1, wherein
a transfer speed of a read access to the second storage device is faster than a transfer speed of a write access to the second storage device, and
in the identify, among the one or more virtual machines, a virtual machine that performs a process with a read ratio larger than a third threshold value is identified as the virtual machine to be moved, where the read ratio is a ratio of a number of read accesses to the first memory to a sum of the number of read accesses to the first memory and a number of write accesses to the first memory.

7. A control method comprising:
identifying, among one or more virtual machines that operate in a first information processing device included in an information processing system, a virtual machine preferable to operate in a second information processing device included in the information processing system as a virtual machine to be moved; and
controlling to move the virtual machine to be moved from the first information processing device to the second information processing device, wherein
the first information processing device includes a first memory, but does not include a first storage device having a storage capacity larger than a storage capacity of the first memory and to be used in place of the first memory,
the second information processing device includes a second memory, and includes a second storage device having a storage capacity larger than a storage capacity of the second memory and to be used in place of the second memory.

8. The control method according to claim 7, wherein in the identifying,
among the one or more virtual machines, a virtual machine that performs a process with a usage of the first memory larger than a first threshold value is identified as the virtual machine to be moved.

9. The control method according to claim 7, wherein in the identifying,
among the one or more virtual machines, a virtual machine that performs a process in which a usage of the first memory has increased within a predetermined period of time is identified as the virtual machine to be moved.

10. The control method according to claim 7, wherein in the identifying,
among the one or more virtual machines, a virtual machine that performs a process in which a page fault has occurred in the first memory is identified as the virtual machine to be moved.

11. The control method according to claim 7, wherein
the first information processing device further includes an arithmetic processing circuit, and
in the identifying, among the one or more virtual machines, a virtual machine that performs a process with a usage rate of the arithmetic processing circuit smaller than a second threshold value is identified as the virtual machine to be moved.

12. The control method according to claim 7, wherein
a transfer speed of a read access to the second storage device is faster than a transfer speed of a write access to the second storage device, and
in the identifying, among the one or more virtual machines, a virtual machine that performs a process with a read ratio larger than a third threshold value is identified as the virtual machine to be moved, where the read ratio is a ratio of a number of read accesses to the first memory to a sum of the number of read accesses to the first memory and a number of write accesses to the first memory.
